(19) United States
(12) Patent Application Publication
(10) Pub. No.: US 2024/0149449 A1
(43) Pub. Date: May 9, 2024

(54) SYSTEMS AND METHODS TO CONFIGURE A ROBOTIC WELDING SYSTEM

(71) Applicant: Illinois Tool Works Inc., Glenview, IL (US)

(72) Inventors: Samantha Noland, Chicago, IL (US); David Savage, Carol Stream, IL (US); Stephen Zuccaro, Cookeville, TN (US); James Manning, Carol Stream, IL (US); Praveen Dandu, Green Bay, WI (US)

(21) Appl. No.: 18/503,636

(22) Filed: Nov. 7, 2023

Related U.S. Application Data
(60) Provisional application No. 63/423,296, filed on Nov. 7, 2022.

(51) Int. Cl. B25J 9/16; B25J 11/00; B25J 13/06

(52) U.S. Cl. CPC B25J 9/1664; B25J 11/005; B25J 13/065

(57) ABSTRACT

Disclosed example robotic welding systems include: a robotic manipulator configured to manipulate a welding torch; a first input device attached to the robotic manipulator and configured to receive rotational and translational inputs; a second input device attached to the robotic manipulator and configured to receive a masking input; and a robot control system, comprising: a processor; and a machine readable storage medium comprising machine readable instructions which, when executed by the processor, cause the processor to: in response to activation of the masking input via the second input device, masking at least a portion of the inputs received via the first input device; and in response to inputs to the first input device, move the robotic manipulator according to the inputs and based on whether the inputs are masked.

### RELATED APPLICATIONS

The present application claims the benefit of U.S. Provisional Patent Application Ser. No. 63/423,296, filed Nov. 7, 2022, entitled “SYSTEMS AND METHODS TO CONFIGURE A ROBOTIC WELDING SYSTEM.” The entirety of U.S. Provisional Patent Application Ser. No. 63/423,296 is expressly incorporated herein by reference.

### FIELD OF THE DISCLOSURE

This disclosure relates generally to robotic welding and, more particularly, to systems and methods to configure a robotic welding system.

### BACKGROUND

Robotic welding is often used to perform repetitive welding operations involving workpieces having a consistent configuration and series of welds to be performed. Collaborative robots are a type of robot which include features enabling use within a closer proximity to personnel than conventional robots.

### SUMMARY

Systems and methods to configure a robotic welding system are disclosed, substantially as illustrated by and described in connection with at least one of the figures, as set forth more completely in the claims.

### BRIEF DESCRIPTION OF THE DRAWINGS

FIG. 1 illustrates an example robotic welding system to perform welding, including a welding-type power supply and a robot control system, in accordance with aspects of this disclosure.

FIG. 2 is a block diagram of an example implementation of the welding-type power supply and the robot control system of FIG. 1.

FIG. 3 is a block diagram of another example implementation of the welding-type power supply and the robot control system of FIG. 1.

FIG. 4A is a more detailed illustration of the example robotic manipulator, welding torch, and input devices of FIG. 1, including a mapping of a frame of reference of the input device(s) to the robotic manipulator.

FIG. 4B illustrates the example robotic manipulator, welding torch, and input devices of FIG. 4A, including a mapping of a frame of reference of the input device(s) to the robotic manipulator while a rotation masking input is active.

FIG. 4C illustrates the example robotic manipulator, welding torch, and input devices of FIG. 4A, including a mapping of a frame of reference of the input device(s) to the robotic manipulator while a translational masking input is active.

FIG. 5 illustrates the example input device of FIG. 4B including indicators to indicate masked and/or unmasked input directions.

FIGS. 6A and 6B illustrate a flowchart representative of example machine readable instructions which may be executed by the example robot control system of FIGS. 1, 2, and/or 3 to configure a robotic welding system by masking inputs for controlling the robotic manipulator.

The figures are not necessarily to scale. Where appropriate, similar or identical reference numbers are used to refer to similar or identical components.

### DETAILED DESCRIPTION

For the purpose of promoting an understanding of the principles of this disclosure, reference will be now made to the examples illustrated in the drawings and specific language will be used to describe the same. It will nevertheless be understood that no limitation of the scope of the claims is intended by this disclosure. Modifications in the illustrated examples and such further applications of the principles of this disclosure as illustrated therein are contemplated as would typically occur to one skilled in the art to which this disclosure relates.

To program robotic welding procedures, conventional robotic welding systems rely on the use of a teach pendant, or other computing device, and/or rely on the use of a free drive mode that can be hand guided to desired locations by an operator. However, in some circumstances, the free drive mode can be difficult to precisely position. Additionally, the use of a teach pendant to perform precision movements may not be intuitive to an operator, because the frame of reference of the teach pendant directionality commands may not be intuitively mapped to the frame of reference of the robotic welding system.

To improve the intuitiveness of precision adjustment of the robotic manipulator, the CR Weld introduced a motion sensor positioned on the robotic manipulator, which allows an operator to precisely manipulate the robotic manipulator in up to 6 degrees-of-freedom (6DOF).

Disclosed example systems and methods further improve the ease of control of a robotic manipulator for teaching robotic welding procedures by limiting unintended movements of the robotic manipulator by the operator. In some examples, the operator may activate a masking input to a 6DOF device to mask one or more dimensions of movement by the 6DOF devices. For example, for a 6DOF device having rotational and translational inputs, the rotational inputs may be masked by a rotation masking input and/or the translational inputs may be masked by a translation masking input.

By masking a subset of the inputs, the operator may limit the types of movement that are controlled by the 6DOF device. For example, an operator guides the robotic manipulator to a desired orientation near to the desired location. The operator may then mask the rotational inputs from the 6DOF device, so that inputs to the 6DOF device mask (e.g., ignore) rotation inputs and movement of the robotic manipulator is limited to translational movement. In this manner, the operator may retain the configured orientation of the robotic manipulator while adjusting the position.

Conversely, an operator may guide the robotic manipulator to a desired location with nearly a desired orientation. The operator may then mask the translational inputs from the 6DOF device, so that inputs to the 6DOF device mask (e.g., ignore) translation inputs and movement of the robotic manipulator is limited to rotational movement. In this manner, the operator may retain the configured location of the robotic manipulator (e.g., of the tool center point (TCP)) while adjusting the angle of the robotic manipulator or torch.

In some examples, a three-position switch is attached to the robotic manipulator near the torch. In some examples, the three-position switch is a push-button switch, in which: a first, outermost position is a disengaged position; a middle, partially depressed position activates a free-drive mode; and a third, fully depressed position causes the robotic manipulator to lock into position until the switch is released. In this manner, the three-position switch may help prevent unintended movements and/or collisions caused by personnel who recoil (e.g., grip the three-position switch harder) due to surprise at the release of the robotic manipulator into free drive mode.

In some such examples, the three-position switch may be double actuated (or “double-tapped,” in which the switch is engaged twice within a short, predefined time window) to activate one of the masking inputs. The three-position switch, or any other input device, may mask different subsets of the input directions in sequence. For example, a first double actuation of the three-position switch may activate rotational input masking, a second double actuation of the three-position switch may activate translational input masking and deactivate the rotation input masking, and a third double actuation of the three-position switch may deactivate both rotational and translational input masking. In some other examples, a first input (e.g., the three-position switch) is double actuated to activate and deactivate masking of one subset of the input directions (e.g., translational) and a second input (e.g., a weld point programming button, an air move programming button, etc.) is double actuated to activate and deactivate masking of another subset of the input directions (e.g., rotational). Additional inputs may be used to activate and deactivate additional subset(s) of the input directions. The subsets of input directions may have overlapping directions or be non-overlapping.

As used herein, the word “exemplary” means “serving as an example, instance, or illustration.” The examples described herein are not limiting, but rather are exemplary only. It should be understood that the described examples are not necessarily to be construed as preferred or advantageous over other examples. Moreover, the terms “examples of the invention,” “examples,” or “invention” do not require that all examples of the invention include the discussed feature, advantage, or mode of operation.

As utilized herein the terms “circuits” and “circuitry” refer to physical electronic components (i.e. hardware) and any software and/or firmware (code) that may configure the hardware, be executed by the hardware, and/or otherwise be associated with the hardware. As used herein, for example, a particular processor and memory may comprise a first “circuit” when executing a first set of one or more lines of code and may comprise a second “circuit” when executing a second set of one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y and z”. As utilized herein, the term “exemplary” means serving as a non-limiting example, instance, or illustration. As utilized herein, the terms “e.g.” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by an operator-configurable setting, factory trim, etc.).

As used herein, a welding-type power source refers to any device capable of, when power is applied thereto, supplying welding, cladding, plasma cutting, induction heating, laser (including laser welding and laser cladding), carbon arc cutting or gouging and/or resistive preheating, including but not limited to transformer-rectifiers, inverters, converters, resonant power supplies, quasi-resonant power supplies, switch-mode power supplies, etc., as well as control circuitry and other ancillary circuitry associated therewith.

Disclosed example robotic welding systems include: a robotic manipulator configured to manipulate a welding torch; a first input device attached to the robotic manipulator and configured to receive rotational and translational inputs; a second input device attached to the robotic manipulator and configured to receive a masking input; and a robot control system, comprising: a processor; and a machine readable storage medium comprising machine readable instructions which, when executed by the processor, cause the processor to: in response to activation of the masking input via the second input device, masking at least a portion of the inputs received via the first input device; and in response to inputs to the first input device, move the robotic manipulator according to the inputs and based on whether the inputs are masked.

In some examples, the first input device includes a joystick. In some such examples, the first input device includes a 6-degrees-of-freedom joystick.

In some example robotic welding systems, the second input device is attached to a joint positioned between the robotic manipulator and the welding torch. In some example robotic welding systems, the second input device includes a three-position switch. In some example robotic welding systems, the second input device is configured to activate the masking input by a double actuation of the three-position switch. In some example robotic welding systems, the joint includes a programming input device configured to instruct the processor to generate a command in a robotic welding procedure.

In some example robotic welding systems, the instructions, when executed, cause the processor to control the robotic manipulator in a free drive mode while the three-position switch is actuated to a middle position. In some example robotic welding systems, the instructions, when executed, cause the processor to control the robotic manipulator to lock all joints of the robotic manipulator into a current position while the three-position switch is actuated to a fully actuated position.

In some example robotic welding systems, the instructions, when executed, cause the processor to: in response to a single actuation of the second input device, instruct the processor to generate a command in the robotic welding procedure; and in response to a double actuation of the second input device, activate the masking input.

In some example robotic welding systems, the masking input includes a rotation masking input, and the instructions, when executed, cause the processor to limit rotation of the robotic manipulator while the rotation masking input is active. In some example robotic welding systems, the masking input includes a translation masking input, and the instructions, when executed, cause the processor to limit translation of the robotic manipulator with respect to a predetermined point on the robotic manipulator while the translation masking input is active.

Some example robotic welding systems further include indicators for each translational dimension and each rotational dimension that can be controlled via the second device, in which the instructions, when executed, cause the processor to control the indicators based on the inputs that are masked.

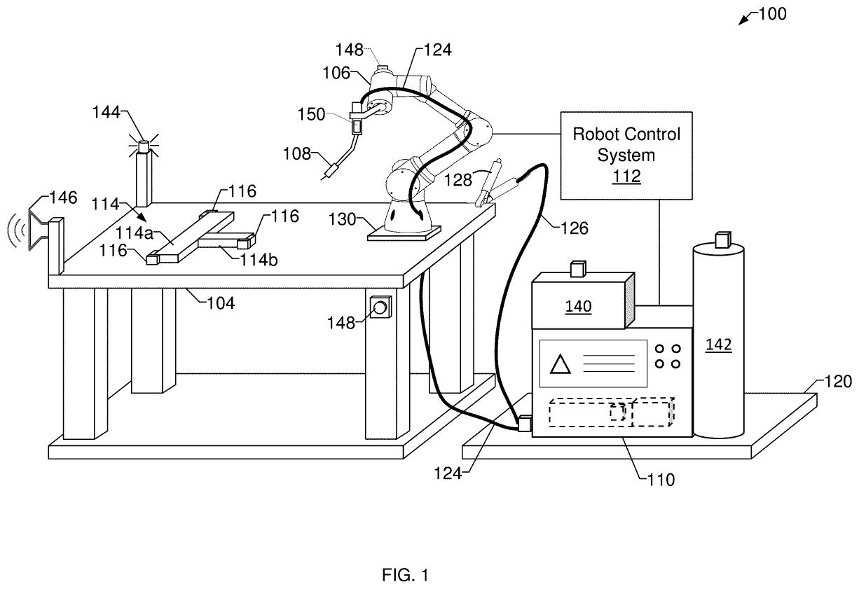

FIG. 1 illustrates an example robotic welding system 100 to perform welding. The example robotic welding system 100 of FIG. 1 includes a welding table 104, a robotic manipulator 106 configured to manipulate a welding torch 108, a welding-type power supply 110, and a robot control system 112.

The welding table 104, robotic manipulator 106, the welding torch 108, the welding-type power supply 110, and/or the robot control system 112, and/or subgroups of these components, may be packaged together (e.g., pre-assembled, pre-calibrated) to provide rapid setup of the robotic welding system 100 for welding at the end-user location. The robotic welding system 100 may be used to make repetitive welds, to leverage the consistency and repeatability advantages of the robotic manipulator 106. In the example of FIG. 1, the robotic manipulator 106 and/or the robot control system 112 are configured as a collaborative robot, which provides features that make the robotic manipulator 106 more conducive to working in areas in which people are proximate the robotic welding system 100.

In the example of FIG. 1, a workpiece 114 is positioned on the welding table 104. The workpiece 114 may include multiple components 114a, 114b which are to be welded together at one or more joints. To provide consistency in arrangement of the workpiece components 114a, 114b, the robotic welding system 100 may further include fixtures 116 attached to the welding table 104. The fixtures 116 may guide the placement of the components 114a, 114b, which can be used to consistently place the multiple components 114a, 114b.

During a welding operation or welding procedure, the robotic welding system 100 manipulates the welding torch 108, such as the illustrated welding torch, to which power is delivered by the welding-type power supply 110 via a first conductor 124 and returned by way of a work cable 126 and a work clamp 128 coupled to the weld table 104. The welding equipment may further include, for example, a source of shielding gas 142, a wire feeder 140, and other accessories and/or equipment. Other accessories and/or equipment may include, for example, water coolers, fume extraction devices, one or more controllers, sensors, user interfaces, and/or communication devices (wired and/or wireless).

The example robotic welding system 100 is configured to form a weld using any known electric welding techniques. Example electric welding techniques include shielded metal arc welding (SMAW), MIG, flux-cored arc welding (FCAW), TIG, laser welding, sub-arc welding (SAW), stud welding, friction stir welding, and resistance welding. In some examples, the welding-type power supply 110 and/or other welding equipment are configured to support one or more, but fewer than all, types of welding processes. To change welding processes, the welding-type power supply 110, torch 108, and/or other welding equipment may be removed (e.g., disconnected and moved away from the robotic welding system 100) and replaced by a different welding-type power supply, torch, and/or other welding equipment that supports the desired welding process. To facilitate ease of movement, the example welding equipment may be mounted or attached to a cart 120 or other conveyance (e.g., ground conveyance, hanging conveyance, etc.). Additionally or alternatively, multiple different types of welding equipment (e.g., multiple power supplies having different capabilities, multiple torches, etc.) may be co-located (e.g., proximate to a same robotic manipulator 106, on a rack of equipment, etc.) to enable rapid reconfiguration of the robotic welding system 100.

The example robotic manipulator 106 may operate using any number of degrees of freedom to manipulate the welding torch 108. For example, the robotic manipulator 106 may include multiple joints, in which each joint has one or more degrees of freedom, to achieve multiple orientations for accessing one or more weld joints on the workpiece 114. Whereas conventional welding robots are contained within a weld cell that is protected against intrusion by operators during robot operations (e.g., welding operations and/or other movement by the robot), in some examples the robotic welding system 100 is configured as a cobot, has a controller or processor, as well as one or more sensors, that are configured to operate in a manner such that humans do not necessarily need to be excluded from the area in which the robotic manipulator 106 is operating. For example, the robotic manipulator 106 may rapidly detect and respond to collisions, may operate with reduced speed and/or joint torque relative to conventional welding robots, and/or implement other features.

The robotic manipulator 106 is coupled to the table 104 via a base 130. Once secured, the base 130 is fixed with respect to the table 104, and may serve as a reference for position and/or orientation for the robotic manipulator 106.

The example robotic manipulator 106 and/or the example robot control system 112 are configured to transmit commands, requests, data, and/or other messages and/or communications to the power supply 110 via one or more protocols. The robotic manipulator 106 and/or the robot control system 112 are further configured to receive responses, acknowledgments, data, and/or other messages and/or communications from the power supply 110 via the one or more protocols. Based on a robotic welding procedure, the robotic manipulator 106 and/or the robot control system 112 may communicate parameters to the power supply 110 for configuration according to the robotic welding procedure, and/or adjust the welding-type process based on the variables and/or other data obtained from the power supply 110 while performing welding operations. In addition to communication with the power supply 110, the robotic manipulator 106, and/or the robot control system 112, the power supply 110, the robotic manipulator 106, and/or the robot control system 112 may communicate with other welding equipment (e.g., a welding accessory, such as the wire feeder 140, a shielding gas supply valve, a welding wire preheating system, a fume extraction system) and/or other robotic equipment.

The example robotic welding system 100 of FIG. 1 further includes a visual output device 144, an audio output device 146, and a user input device 148. The visual output device 144 and/or the audio output device 146 are positioned proximate to the robotic manipulator 106 and/or the welding table 104, such that any visual and/or audible notifications are associated with the robotic welding system 100 (e.g., to the exclusion of other robot control systems that may be present in the same facility). While the example system 100 includes audio and/or visual output devices, any other type of notification may be provided. For example, notifications disclosed herein may be performed via any type of audible, visual, haptic, tactile, and/or other perceptible feedback, and may be individually applied or broadly applied.

To notify personnel in the area around the robot control system 112 that an arc is about to be struck, the robot control system 112 outputs at least one of a visual notification (e.g., via the visual output device 144, via a control pendant, via another device in the facility, etc.) and/or an audible notification (e.g., via the audio output device 146, via a facility speaker, etc.) proximate to the robotic manipulator 106 and the welding table 104. In the example of FIG. 1, the robot control system 112 outputs such notifications in response to initiation of a robotic welding procedure involving the robotic manipulator 106, but prior to starting the robotic welding procedure. The notifications may be timed so as to provide nearby personnel sufficient time to cover and/or avert their eyes.

The example visual output device 144 and/or the audio output device 146, or one or more additional notification device(s), may additionally or alternatively indicate one or more operating modes of the robotic welding system 100. For example, the robotic welding system 100 may operate in a welding mode (e.g., the robot control system 112 and the welding-type power supply 110 perform one or more arc welds), in a dry run mode (e.g., moving the robotic manipulator 106 without an arc to verify a weld path), in a free motion mode (e.g., allowing the operator to freely move the robotic manipulator 106 and/or the torch 108 to perform training or other operation), a disabled mode (e.g., the robotic manipulator 106 is held in a position, such as for maintenance or other activities near the robotic manipulator 106), and/or any other operating modes. The visual output device 144 and/or the audio output device 146 may indicate the mode of operation instead of providing warnings or notifications of impending arcs. The mode indication may be visually or audibly distinguishable from a notification or warning of an impending arc.

To control motion of the robotic manipulator 106 during programming, the robotic welding system 100 includes one or more input devices 148, 150 attached to the robotic manipulator 106. The example input device 148 is a 6DOF joystick, or other type of multi-dimensional motion control device with any number of degrees-of-freedom. Motions of the input device 148 are mapped by the robot control system 112 to a frame of reference of the robotic manipulator 106 to allow the operator to perform movements of the robotic manipulator 106 by applying corresponding motions to the input device 148.

The example input device(s) 150 are located on a programming joint 152, which may be structurally attached to the robotic manipulator 106 and/or to the torch 108 to enable the operator to guide the robotic manipulator in free drive mode by applying force to the programming joint 152. The example programming joint 152 may include multiple ones of the input devices, such as inputs which are easily used and understood while the operator is guiding the robotic manipulator 106 by hand (e.g., without repeatedly releasing the robotic manipulator 106 to use a separate teach pendant device). For example, the programming joint 152 may include free drive or release trigger inputs, weld point inputs, non-arc movement inputs, path generation mode selection inputs (e.g., linear vs. curved path generation), and/or any other desired inputs.

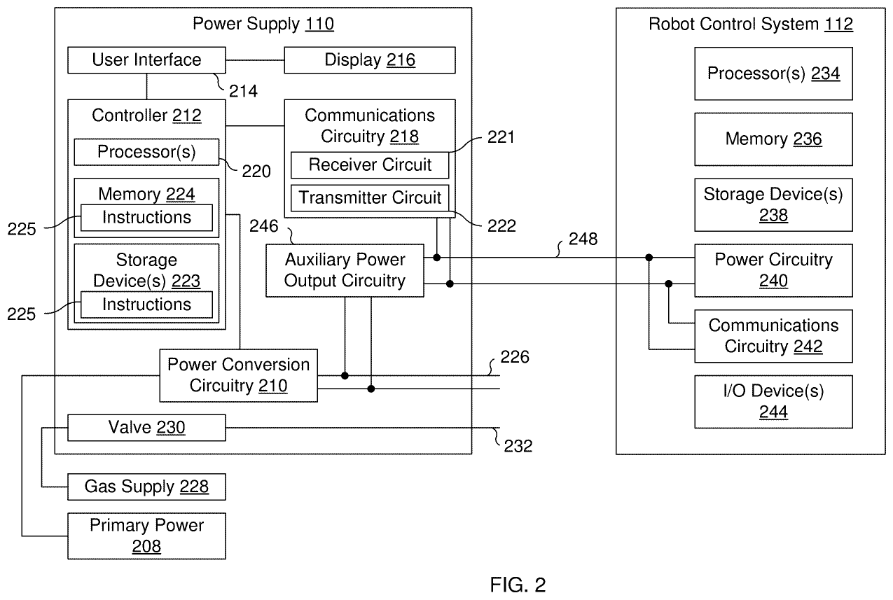

FIG. 2 is a block diagram of an example implementation of the welding-type power supply 110 and the robot control system 112 of FIG. 1. The example welding-type power supply 110 powers, controls, and supplies consumables to a welding application. In some examples, the welding-type power supply 110 directly supplies input power to the welding torch 108. In the illustrated example, the welding-type power supply 110 is configured to supply power to welding operations and/or preheating operations. The example welding-type power supply 110 may also provide power to a wire feeder to supply electrode wire to the welding torch 108 for various welding applications (e.g., GMAW welding, flux core arc welding (FCAW)).

The welding-type power supply 110 receives primary power 208 (e.g., from the AC power grid, an engine/generator set, a battery, or other energy generating or storage devices, or a combination thereof), conditions the primary power, and provides an output power to one or more welding devices and/or preheating devices in accordance with demands of the system. The primary power 208 may be supplied from an offsite location (e.g., the primary power may originate from the power grid). The welding-type power supply 110 includes a power conversion circuitry 210, which may include transformers, rectifiers, switches, and so forth, capable of converting the AC input power to AC and/or DC output power as dictated by the demands of the system (e.g., particular welding processes and regimes). The power conversion circuitry 210 converts input power (e.g., the primary power 208) to welding-type power based on a weld voltage setpoint and outputs the welding-type power via a weld circuit.

In some examples, the power conversion circuitry 210 is configured to convert the primary power 208 to both welding-type power and auxiliary power outputs. However, in other examples, the power conversion circuitry 210 is adapted to convert primary power only to a weld power output, and a separate auxiliary converter is provided to convert primary power to auxiliary power. In some other examples, the welding-type power supply 110 receives a converted auxiliary power output directly from a wall outlet. Any suitable power conversion system or mechanism may be employed by the welding-type power supply 110 to generate and supply both weld and auxiliary power.

The welding-type power supply 110 includes a controller 212 to control the operation of the welding-type power supply 110. The welding-type power supply 110 also includes a user interface 214. The controller 212 receives input from the user interface 214, through which a user may choose a process and/or input desired parameters (e.g., voltages, currents, particular pulsed or non-pulsed welding regimes, and so forth). The user interface 214 may receive inputs using any input device, such as via a keypad, keyboard, buttons, touch screen, voice activation system, wireless device, etc. Furthermore, the controller 212 controls operating parameters based on input by the user as well as based on other current operating parameters. Specifically, the user interface 214 may include a display 216 for presenting, showing, or indicating, information to an operator. The controller 212 may also include interface circuitry for communicating data to other devices in the system, such as the wire feeder, the robotic manipulator 106, and/or the robot control system 112. For example, in some situations, welding-type power supply 110 wirelessly communicates with other welding devices within the welding system. Further, in some situations, the welding-type power supply 110 communicates with other welding devices using a wired connection, such as by using a network interface controller (NIC) to communicate data via a network (e.g., ETHERNET, 10baseT, 10base100, etc.).

The controller 212 includes at least one controller or processor 220 that controls the operations of the welding-type power supply 110. The controller 212 receives and processes multiple inputs associated with the performance and demands of the system. The processor 220 may include one or more microprocessors, such as one or more “general-purpose” microprocessors, one or more special-purpose microprocessors and/or ASICS, and/or any other type of processing device. For example, the processor 220 may include one or more digital signal processors (DSPs).

The example controller 212 includes one or more storage device(s) 223 and one or more memory device(s) 224. The storage device(s) 223 (e.g., nonvolatile storage) may include ROM, flash memory, a hard drive, and/or any other suitable optical, magnetic, and/or solid-state storage medium, and/or a combination thereof. The storage device 223 stores data (e.g., data corresponding to a welding application), instructions (e.g., software or firmware to perform welding processes), and/or any other appropriate data. Examples of stored data for a welding application include an attitude (e.g., orientation) of a welding torch, a distance between the contact tip and a workpiece, a voltage, a current, welding device settings, and so forth.

The memory device 224 may include a volatile memory, such as random access memory (RAM), and/or a nonvolatile memory, such as read-only memory (ROM). The memory device 224 and/or the storage device(s) 223 may store a variety of information and may be used for various purposes. For example, the memory device 224 and/or the storage device(s) 223 may store processor executable instructions 225 (e.g., firmware or software) for the processor 220 to execute. In addition, one or more control regimes for various welding processes, along with associated settings and parameters, may be stored in the storage device 223 and/or memory device 224, along with code configured to provide a specific output (e.g., initiate wire feed, enable gas flow, capture welding current data, detect short circuit parameters, determine amount of spatter) during operation.

In some examples, the welding power flows from the power conversion circuitry 210 through a weld cable 226. The example weld cable 226 is attachable and detachable from weld studs at each of the welding-type power supply 110 (e.g., to enable ease of replacement of the weld cable 226 in case of wear or damage). Furthermore, in some examples, welding data is provided with the weld cable 226 such that welding power and weld data are provided and transmitted together over the weld cable 226.

In some examples, the welding-type power supply 110 includes or is implemented in a wire feeder.

The example communications circuitry 218 includes a receiver circuit 221 and a transmitter circuit 222. Generally, the receiver circuit 221 receives data transmitted by the robotic manipulator 106 and/or the robot control system 112, and the transmitter circuit 222 transmits data to the robotic manipulator 106 and/or the robot control system 112.

In some examples, a gas supply 228 provides shielding gases, such as argon, helium, carbon dioxide, and so forth, depending upon the welding application. The shielding gas flows to a valve 230, which controls the flow of gas, and if desired, may be selected to allow for modulating or regulating the amount of gas supplied to a welding application. The valve 230 may be opened, closed, or otherwise operated by the controller 212 to enable, inhibit, or control gas flow (e.g., shielding gas) through the valve 230. Shielding gas exits the valve 230 and flows through a gas line 232 (which in some implementations may be packaged with the welding power output) to the wire feeder which provides the shielding gas to the welding application. In some examples, the welding-type power supply 110 does not include the gas supply 228, the valve 230, and/or the gas line 232.

The example robot control system 112 of FIG. 2 includes processor(s) 234, memory 236, one or more storage device(s) 238, power circuitry 240, communications circuitry 242, and one or more I/O device(s) 244.

The example processor(s) 234 execute instructions to configure and/or program a robotic welding procedure, and/or generates commands to execute a robotic welding procedure via the robotic manipulator 106. The processor(s) 234 may include one or more microprocessors, such as one or more “general-purpose” microprocessors, one or more special-purpose microprocessors and/or ASICS, and/or any other type of processing device. For example, the processor(s) 234 may include one or more digital signal processors (DSPs). The memory device 236 may include a volatile memory, such as random access memory (RAM), and/or a nonvolatile memory, such as read-only memory (ROM). The memory device 236 and/or the storage device(s) 238 may store a variety of information and may be used for various purposes. For example, the memory device 236 and/or the storage device(s) 238 may store processor executable instructions (e.g., firmware or software) for the processor(s) 234 to execute. In addition, one or more control regimes for various robotic manipulators and/or robotic welding procedures, along with associated settings and parameters, may be stored in the storage device(s) 238 and/or memory device 236. The storage device(s) 238 (e.g., nonvolatile storage) may include ROM, flash memory, a hard drive, and/or any other suitable optical, magnetic, and/or solid-state storage medium, and/or a combination thereof. The storage device(s) 238 store data (e.g., data corresponding to a welding application), instructions (e.g., software or firmware to perform welding processes), and/or any other appropriate data.

The power circuitry 240 converts input power to power usable by the robot control system 112 (e.g., by the processor(s) 234, the memory 236, the storage device(s) 238, communications circuitry 242, the I/O device(s) 244, and/or the robotic manipulator 106). In the example of FIG. 2, the robot control system 112 is plugged into welding-type power supply 110 to provide operational power to the robot control system 112 and/or the robotic manipulator 106. In the illustrated example, the power supply 110 includes auxiliary power output circuitry 246, which converts input power (e.g., output power from the power conversion circuitry 210, primary power 208) to auxiliary power, such as a standard AC output (e.g., 120 VAC or 240 VAC at 50 Hz or 60 Hz). In such examples, the robot control system 112 can be plugged into the power supply 110 instead of mains power, and receives the auxiliary power via an auxiliary power connection (e.g., auxiliary power conductors 248 such as an AC power cord).

The example communications circuitry 218 and the communications circuitry 242 of FIG. 2 are configured to communicate via the auxiliary power connection. In examples in which the auxiliary power conductors 248 are configured to transmit 120 VAC power (or other high-voltage AC power), the communications circuitry 218 and the communications circuitry 242 may be configured to comply with the IEEE Standard 1901-2010 and/or any other power line communication standard or technique compatible with high-speed communication over the auxiliary power connection.

The I/O device(s) 244 may include operator or user interfaces and/or other data interfaces. Example I/O device(s) 244 may include a keyboard, a keypad, a mouse, a trackball, a pointing device, a microphone, an audio speaker, a display device, an optical media drive, a multi-touch touch screen, a gesture recognition interface, a magnetic media drive, and/or any other operator interface devices to enable an operator to view information about the robot control system 112, the robotic manipulator 106, a robotic welding procedure, the connected power supply 110 and/or any other connected welding equipment, and/or any other information. For example, the I/O device(s) 244 may include input and/or output device(s) to control movement of the robotic manipulator 106, such as a teach pendant (e.g., a computing device executing software allowing the user to configure robotic welding procedures, welding parameters, and/or any other aspects of the robotic welding system 100), a multi-directional (e.g., 6DOF) input device attached to the robotic manipulator 106 to control motion of the robotic manipulator, and/or dedicated programming devices positioned on the robotic manipulator 106 for use while guiding the robotic manipulator 106 in free drive mode. In other examples, the communications circuitry 242 may also include a communication interface to communicate with and control the robotic manipulator 106.

The power supply 110 may be connected to the example robot control system 112 by plugging the robot control system 112 into the power supply 110 via the auxiliary power connection (e.g., a 120 VAC outlet on the power supply). While the power supply 110 is outputting the auxiliary output power and after the robot control system 112 is powered on and initialized, the power supply 110 and the robot control system 112 may automatically pair by communicating via the auxiliary power connection. To perform the pairing, the power supply 110 detects, via the communications circuitry 218, that the robot control system is coupled to the auxiliary power connection. For example, the communications circuitry 218 (and/or the communications circuitry 242) outputs messages via the auxiliary power connection, which are received and/or acknowledged by the communications circuitry 242 (or the communications circuitry 218).

In response to detecting the robot control system 112 via the auxiliary power connection and receiving communications from the robot control system 112, the controller 212 configures the welding-type power supply 110. For example, upon establishing communication between the robot control system 112 and the power supply 110, the power supply 110 may transmit to the robot control system 112 information that can be used to configure the power supply 110. The robot control system 112 can then provide commands to the power supply 110 to configure the power supply 110 to perform the desired welding processes as part of a robotic welding procedure.

Example information that may be automatically transmitted to the robot control system 112 by the power supply 110 may include an: identifier of a paired welding-type power supply (e.g., a serial number, an assigned name, etc.), an identification of capabilities of a paired welding-type power supply (e.g., a listing of features and/or modifiable parameters, a model number, etc.), software instructions to facilitate control of the welding-type power supply 110 by the robot control system 112 (e.g., a software application or plug-in, software updates, software routines, an API, etc.), identification of a welding capability of the welding-type power supply (e.g., a listing of available welding processes), identification of an adjustable parameter of the welding-type power supply (e.g., parameters that are typically used by an operator, parameters that are modifiable by typically hidden from the operator, robotic welding-specific parameters, etc.) identification of a parameter limitation of the welding-type power supply (e.g., voltage limits, current limits, power limits, wire feed speed limits, frequency limits, etc.), a robotic welding procedure and/or welding-type parameters to perform the robotic welding procedure (e.g., a stored, predefined set of instructions to be implemented by the robot control system 112 to perform a robotic welding procedure), and/or any other information that may be transferred between the power supply 110 and the robot control system 112. Additionally or alternatively, the welding-type power supply 110 may transmit one or more available real-time process data streams, such as welding current measurements, output voltage measurements, wire feed speed measurements. The robot control system 112 may use real-time process data streams for other aspects of the robotic welding procedure, such as process control, seam tracking, and/or any other control.

Additionally or alternatively, the welding-type power supply 110 may transmit information about physical system needs, such as the need for physical isolation or other physical configuration to be performed by the operator, to the robot control system 112. Based on the physical configuration information, the robot control system 112 may display the physical information to an operator via a display or otherwise notify the operator of the physical requirements. Additionally or alternatively, the welding-type power supply 110 may transmit system status information about one or more components of the welding system, for display by the robot control system 112 or other action. Example welding equipment system status information may include internal temperature measurements, airflow measurements, coolant circulation information, error codes and/or other diagnostic information, and/or any other status information.

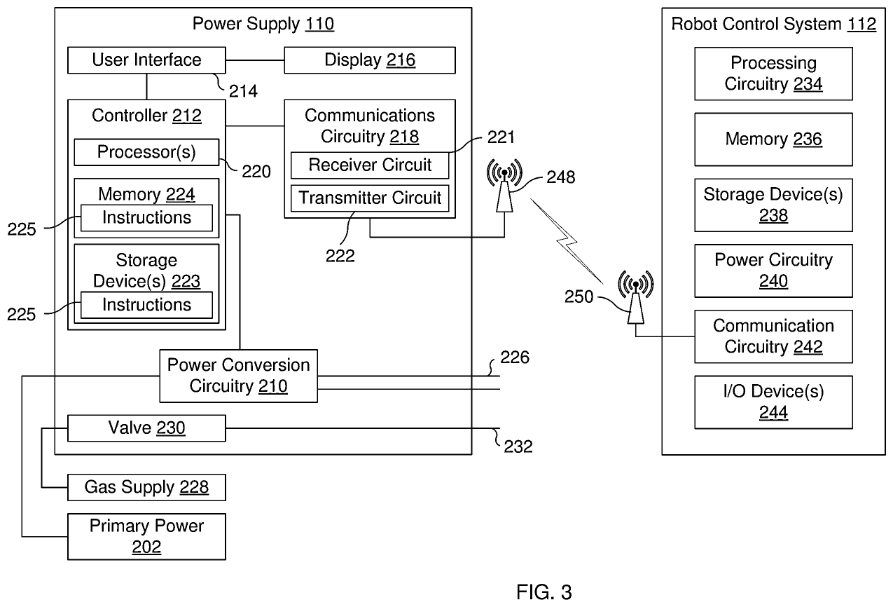

FIG. 3 is a block diagram of another example implementation of the welding-type power supply 110 and the robot control system 112 of FIG. 1. The example power supply 110 of FIG. 3 includes the components of the example power supply 110 of FIG. 2, but may include or omit the auxiliary power output circuitry 246. The example robot control system 112 of FIG. 3 includes the components of the robot control system 112 of FIG. 2.

In contrast with the power line communication of FIG. 2, the example welding-type power supply 110 and the robot control system 112 of FIG. 3 communicate via wireless communications. To this end, the example communications circuitry 218 and communications circuitry 242 are connected to respective antennas 249, 250.

While establishment of communications may occur automatically using power line communications as in FIG. 2, the example robot control system 112 and/or the power supply 110 may require initiation of pairing by the operator (e.g., via the user interface 214 and the I/O device(s) 244) to establish communication between the robot control system 112 and/or the power supply 110. For example, the operator may select a “Pair” button on each of the user interface 214 of the power supply 110 and a user interface of the robot control system 112, which then causes the communications circuitry 218 and the communications circuitry 242 to perform a pairing procedure. Upon establishing the communications channel via pairing, the power supply 110 and the robot control system 112 automatically exchange information and/or configure the power supply 110 as discussed above. In some examples, the operator may further be prompted to verify the pairing occurred between the desired power supply 110 and robot control system 112 (e.g., neither the power supply 110 nor the robot control system 112 paired with an unintended device nearby).

While example powerline and wireless communications are disclosed above, the example robot control system 112 and the power supply 110 may be coupled using any communications method, including conventional methods such as a control cable.

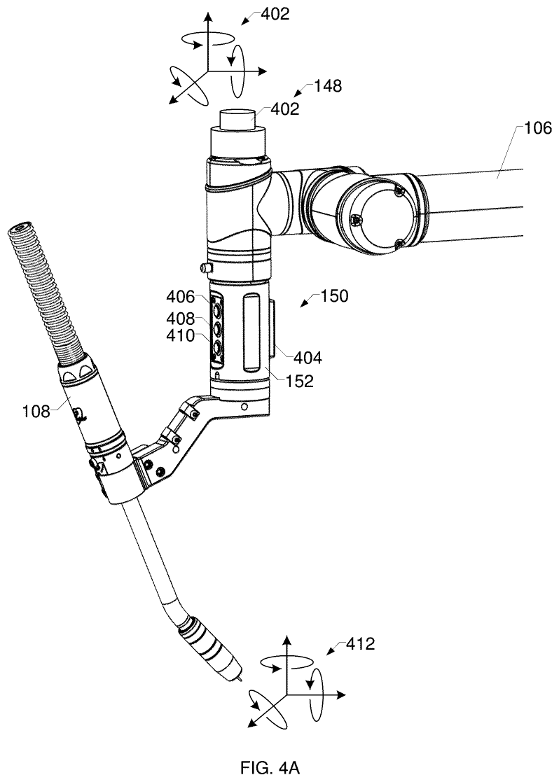

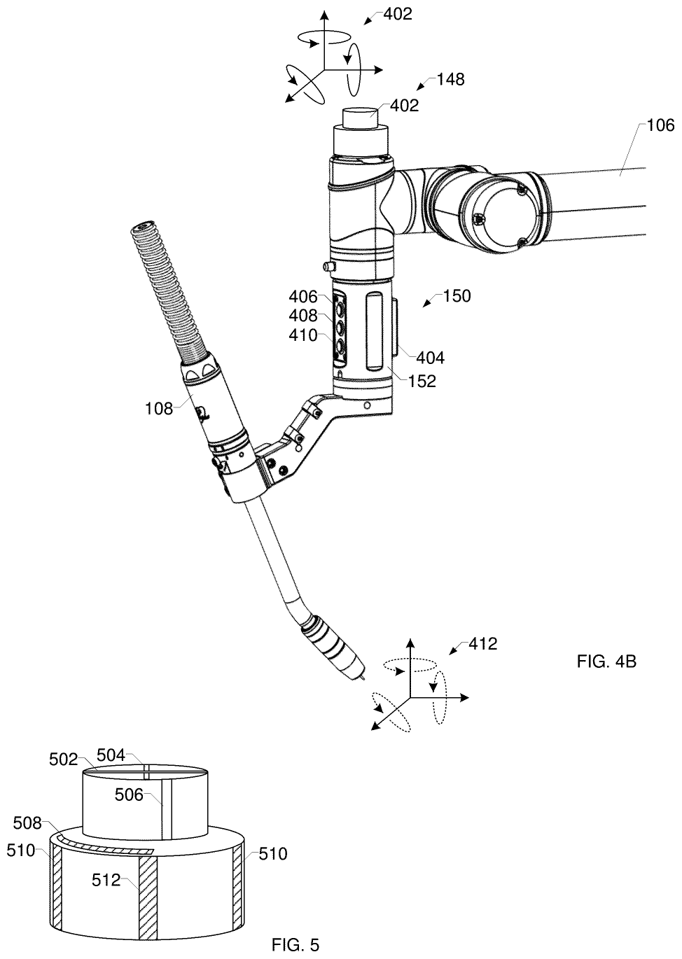

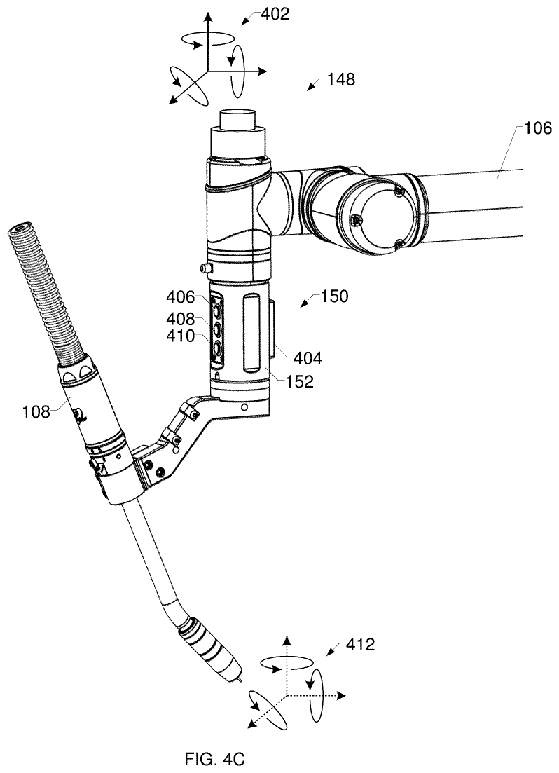

FIG. 4A is a more detailed illustration of the example robotic manipulator 106, welding torch 108, and input devices 148, 150 of FIG. 1, including a mapping of a frame of reference 402 of the input device 148 to the robotic manipulator 106. In the example of FIG. 4A, the input device 148 is a 6DOF joystick, which is aligned with the last revolute joint of the robotic manipulator 106 (e.g., the joint closest to the welding torch 108). The frame of reference 402 of the input device 148 is set based on the mounting position of the input device 148, and the robot control system 112 converts motion (e.g., translation, rotation) in the frame of reference 402 to the frame of reference 412 of the robotic manipulator 106, which may be the TCP (e.g., the nominal tip of the welding wire) or any other location on the welding torch 108 or the robotic manipulator 106.

The input devices 150 of FIG. 4A are attached to the programming joint 152, which is structurally attached between the last revolute joint of the robotic manipulator 106 and the welding torch 108. The input devices 150 include an enabling switch 404 and programming buttons 406-410. The enabling switch 404, when triggered, places the robot control system 112 into a free drive mode, in which the user is permitted to freely move and rotate the robotic manipulator 106 and the welding torch 108 to a desired position. As the robotic manipulator 106 and the welding torch 108 are moved in free drive mode, the robot control system 112 monitors the positions of the joints and the TCP (e.g., using encoders or other sensors in the robotic manipulator 106).

In the example of FIG. 4A, the enabling switch 404 is a three-position switch, such as a three-position push button, a three-position slider, a rocker switch, or other three-position input devices. In the illustrated example, the enabling switch 404 is a three-position push-button switch, in which: a first, outermost position is a disengaged position; a middle, partially depressed position activates a free-drive mode; and a third, fully depressed position causes the robotic manipulator 106 to lock all joints into the current position until the enabling switch 404 is released. In this manner, the enabling switch 404 may help prevent unintended movements and/or collisions caused by personnel who recoil (e.g., grip the three-position switch harder) due to surprise at the enabling of free drive mode for the robotic manipulator 106.

The programming buttons 406-410 may be used by the operator during free drive mode to add program points to the robotic welding procedure. For example, the programming buttons 406-410 may be assigned commands or functions such as: adding a starting, intermediate, or stopping welding point; adding a starting, intermediate, or stopping non-arc movement point; changing path generation modes between linear path generation and curved path generation; point removal (e.g., based on a closest point to the current point), stored position recall (e.g., to cause the robotic manipulator 106 to move to a stored position selected based on one or more criteria); stored orientation recall (e.g., to cause the robotic manipulator 106 to move to a stored orientation selected based on one or more criteria); and/or any other desired programming functions.

The example enabling switch 404 and/or one or more of the programming buttons 406-410 may be double actuated (or “double-tapped,” in which the switch is engaged twice within a short, predefined time window) to activate one of the masking inputs. The enabling switch 404 and/or one or more of the programming buttons 406-410 may mask different subsets of the input directions in sequence. For example, a first double actuation of the enabling switch 404 (e.g., the three-position switch) may activate rotational input masking, a second double actuation of the enabling switch 404 may activate translational input masking and deactivate the rotation input masking, and a third double actuation of the enabling switch 404 may deactivate both rotational and translational input masking.

In some other examples, a first input (e.g., the enabling switch 404) is double actuated to activate and deactivate masking of one subset of the input directions (e.g., translational) and a second input (e.g., the programming button 406) is double actuated to activate and deactivate masking of another subset of the input directions (e.g., rotational). In such examples, the robot control system 112 may respond to a single actuation of the programming button 406-410 by generating a command in the robotic welding procedure, respond to a double actuation of the same programming button 406-410 by activating a masking input. Additional inputs may be used to activate and deactivate additional subset(s) of the input directions. The subsets of input directions may have overlapping directions or be non-overlapping.

While the foregoing examples involve double actuation of one or more inputs, other types of masking activation may be used. For example, dedicated buttons, toggles, switches, and/or any other types of input devices may be used to activate masking of some or all of the potential directions that may be input via the input device 148.

FIG. 4B illustrates the example robotic manipulator 106, welding torch 108, and input devices 148, 404-410 of FIG. 4A, including a mapping of a frame of reference 402 of the input device(s) to the robotic manipulator 106 while a rotation masking input is active. The frame of reference 412 of the robotic manipulator 106 illustrates the masking of the rotation directions, while the translational directions are unmasked and may be used to control movement of the robotic manipulator 106.

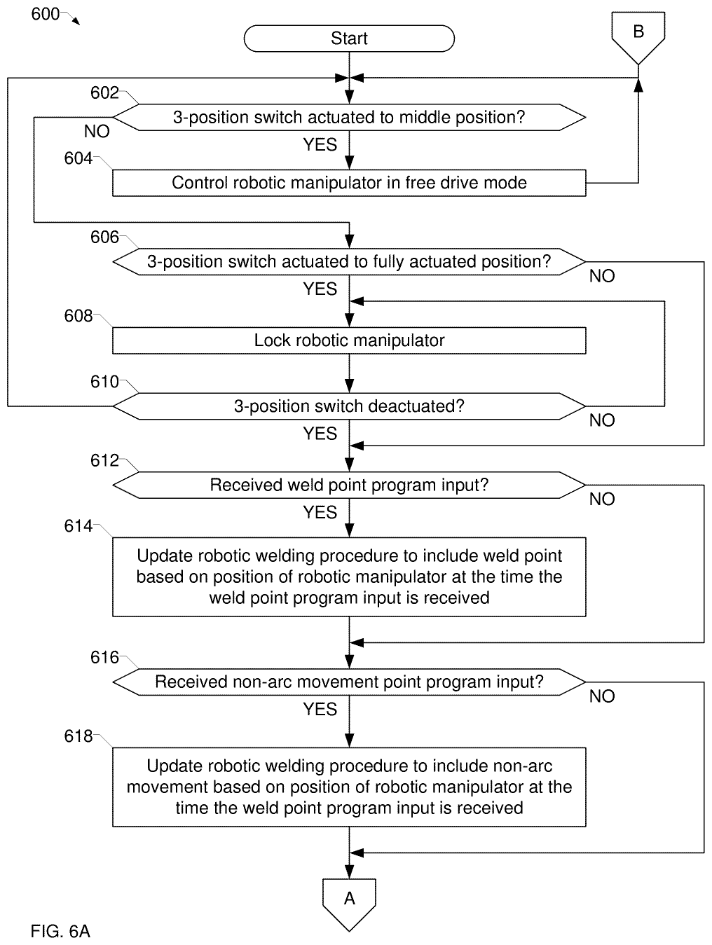

In some examples, the input device 148 may include indicators, such as LED lights, which visually indicate whether masking is active and/or which directions are masked and/or unmasked. FIG. 5 illustrates the example input device 148 of FIG. 4B including indicators 502-512 to indicate masked and/or unmasked input directions. Example indicators 502-506 indicate whether masking is active for translational directions, and indicators 508-512 indicate whether masking is active for rotational directions. The indicators 502-512 may light up when the corresponding direction is masked and unlight when the corresponding direction is unmasked. Alternatively, the indicators 502-512 may light up when the corresponding direction is unmasked and unlight when the corresponding direction is masked. In still other examples, the indicators 502-512 may light up with a first color, pattern, or other feature when the corresponding direction is unmasked and light up with a second color, pattern, or other feature when the corresponding direction is masked. While example arrangements of indicators 502-512 are illustrated in FIG. 5, other arrangements and/or locations may be used.

FIG. 4C illustrates the example robotic manipulator, welding torch, and input devices of FIG. 4A, including a mapping of a frame of reference 402 of the input device 148 to the robotic manipulator 106 while a translational masking input is active. The frame of reference 412 of the robotic manipulator 106 illustrates the masking of the translational directions, while the rotational directions are unmasked and may be used to control movement of the robotic manipulator 106.

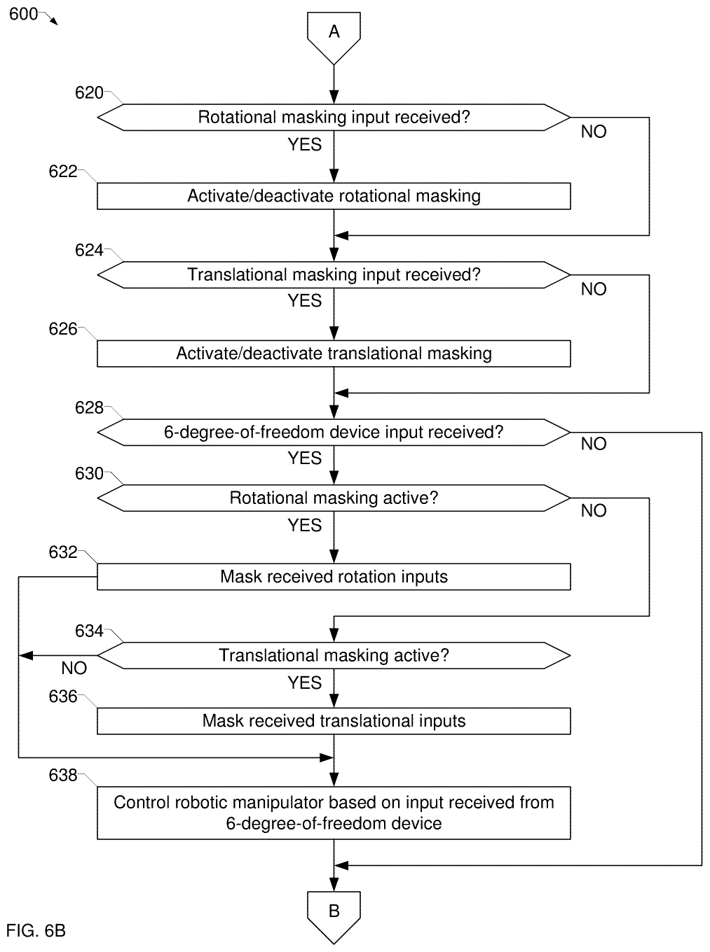

FIGS. 6A and 6B illustrate a flowchart representative of example machine readable instructions 600 which may be executed by the example robot control system of FIGS. 1, 2, and/or 3 to configure a robotic welding system by masking inputs for controlling the robotic manipulator. The example instructions 600 are discussed below with reference to the robot control system 112 of FIG. 2.

At block 602, the example robot control system 112 determines whether a three-position switch (e.g., the enabling switch 404 of FIGS. 4A-4C) is actuated to a middle position. If the enabling switch 404 is actuated to a middle position (block 602), the robot control system 112 controls the robotic manipulator 106 in a free drive mode. For example, the robot control system 112 may permit the user to freely manipulate the positions of the robotic manipulator 106 and welding torch 108 while the free drive mode is enabled (e.g., while the enabling switch 404 is actuated to the middle position in block 602).

If the enabling switch 404 is not actuated to a middle position (block 602), at block 606 the example robot control system 112 determines whether a three-position switch (e.g., the enabling switch 404) is actuated to a fully actuated position (e.g., fully depressed). If the enabling switch 404 is actuated to the fully actuated position (block 606), at block 608 the robot control system 112 locks the robotic manipulator 106 into position. At block 610, the robot control system 112 determines whether the three-position switch (e.g., the enabling switch 404) is deactuated (e.g., released by the operator). If the enabling switch 404 is not deactuated (block 610), control returns to block 608 to keep the robotic manipulator 106 in a locked state. When the enabling switch 404 is deactuated (block 610), control returns to block 602 to monitor the enabling switch 404.

If the enabling switch 404 is not actuated to the fully actuated position (block 606), at block 612 the robot control system 112 determines whether a weld point program input has been received. For example, the robot control system 112 may determine whether one of the programming buttons 406-410 of FIGS. 4A-4C has been selected to add a welding command point to the robotic welding procedure at the current position of the robotic manipulator 106 and/or welding torch 108. If a weld point program input has been received (block 612), at block 614 the robot control system 112 updates the robotic welding procedure to include a weld point based on the position of the robotic manipulator 106 (e.g., determined via encoders and/or other sensors) at the time the weld point program input is received.

If a weld point program input has been received (block 612), at block 616 the robot control system 112 determines whether a non-arc movement point program input has been received. For example, the robot control system 112 may determine whether one of the programming buttons 406-410 of FIGS. 4A-4C has been selected to add a non-arc movement command point to the robotic welding procedure to move from a prior position to the current position of the robotic manipulator 106 and/or welding torch 108. If a non-arc movement point program input has been received (block 616), at block 618 the robot control system 112 updates the robotic welding procedure to include a non-arc movement point based on the position of the robotic manipulator 106 (e.g., determined via encoders and/or other sensors) at the time the non-arc movement point program input is received.

Turning to FIG. 6B, if a non-arc movement point program input has not been received (block 616), at block 620 the robot control system 112 determines whether a rotational masking input has been received. For example, the rotational masking input may be received by double-actuation, or other input or series of inputs. If the rotational masking input has been received (block 620), the robot control system 112 activates (if inactive) or deactivates (if active) the rotational masking. In some examples, the robot control system 112 masks a subset of the rotational inputs and/or changes a subset of the rotational inputs that are masked. If the translational masking is active when activating the rotational masking input, the robot control system 112 may automatically deactivate the translational masking when activating the rotational masking.

After activating or deactivating the rotational masking (block 622), or a rotational masking input has not been received (block 620), at block 624 the robot control system 112 determines whether a translational masking input has been received. For example, the translational masking input may be received by double-actuation, or other input or series of inputs, which may be the same or different than the rotational masking input. If the translational masking input has been received (block 624), at block 626 the robot control system 112 activates (if inactive) or deactivates (if active) the translational masking. In some examples, the robot control system 112 masks a subset of the translational inputs and/or changes a subset of the translational inputs that are masked. If the rotational masking is active when activating the translational masking input, the robot control system 112 may automatically deactivate the rotational masking when activating the translational masking.

After activating or deactivating the translational masking (block 626), or a translational masking input has not been received (block 624), at block 628 the robot control system 112 determines whether a 6DOF device input has been received (e.g., from the input device 148). For example, a 6DOF joystick may provide three linear directions of input as well as three rotational directions of input. If a 6DOF device input has been received (block 628), at block 630 the robot control system 112 determines whether rotational masking is active. If rotational masking is active (block 630), at block 632 the robot control system 112 masks (e.g., ignores) received rotational inputs from the input device 148.

If rotational masking is inactive (block 630), at block 634 the robot control system 112 determines whether translational masking is active. If translational masking is active (block 634), at block 636 the robot control system 112 masks (e.g., ignores) received v inputs from the input device 148.

After masking the rotational inputs (block 632) or masking the translational inputs (block 636), or if neither of the rotational or translational masking is active (blocks 630, 634), at block 638 the robot control system 112 controls the robotic manipulator 106 to move based on the inputs received from the 6DOF input device 148. For example, if the rotational or translational inputs are masked, those inputs are not used by the robot control system 112 to move the robotic manipulator 106.

After controlling the robotic manipulator 106 (block 638), or if a 6DOF input has not been received (block 628), control returns to block 602 of FIG. 6A.

The present devices and/or methods may be realized in hardware, software, or a combination of hardware and software. The present methods and/or systems may be realized in a centralized fashion in at least one computing system, processors, and/or other logic circuits, or in a distributed fashion where different elements are spread across several interconnected computing systems, processors, and/or other logic circuits. Any kind of computing system or other apparatus adapted for carrying out the methods described herein is suited. A typical combination of hardware and software may be a processing system integrated into a welding power source with a program or other code that, when being loaded and executed, controls the welding power source such that it carries out the methods described herein. Another typical implementation may comprise an application specific integrated circuit or chip such as field programmable gate arrays (FPGAs), a programmable logic device (PLD) or complex programmable logic device (CPLD), and/or a system-on-a-chip (SoC). Some implementations may comprise a non-transitory machine-readable (e.g., computer readable) medium (e.g., FLASH memory, optical disk, magnetic storage disk, or the like) having stored thereon one or more lines of code executable by a machine, thereby causing the machine to perform processes as described herein. As used herein, the term “non-transitory machine readable medium” is defined to include all types of machine readable storage media and to exclude propagating signals.

An example control circuit implementation may be a microcontroller, a field programmable logic circuit and/or any other control or logic circuit capable of executing instructions that executes weld control software. The control circuit could also be implemented in analog circuits and/or a combination of digital and analog circuitry.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A robotic welding system, comprising:
a robotic manipulator configured to manipulate a welding torch;
a first input device attached to the robotic manipulator and configured to receive rotational and translational inputs;
a second input device attached to the robotic manipulator and configured to receive a masking input; and
a robot control system, comprising:
a processor; and
a machine readable storage medium comprising machine readable instructions which, when executed by the processor, cause the processor to:
in response to activation of the masking input via the second input device, masking at least a portion of the inputs received via the first input device; and
in response to inputs to the first input device, move the robotic manipulator according to the inputs and based on whether the inputs are masked.

2. The robotic welding system as defined in claim 1, wherein the first input device comprises a joystick.

3. The robotic welding system as defined in claim 2, wherein the first input device comprises a 6-degrees-of-freedom joystick.

4. The robotic welding system as defined in claim 1, wherein the second input device is attached to a joint positioned between the robotic manipulator and the welding torch.

5. The robotic welding system as defined in claim 4, wherein the second input device comprises a three-position switch.

6. The robotic welding system as defined in claim 5, wherein the second input device is configured to activate the masking input by a double actuation of the three-position switch.

7. The robotic welding system as defined in claim 6, wherein the joint further comprises a programming input device configured to instruct the processor to generate a command in a robotic welding procedure.

8. The robotic welding system as defined in claim 5, wherein the instructions, when executed, cause the processor to control the robotic manipulator in a free drive mode while the three-position switch is actuated to a middle position.

9. The robotic welding system as defined in claim 8, wherein the instructions, when executed, cause the processor to control the robotic manipulator to lock all joints of the robotic manipulator into a current position while the three-position switch is actuated to a fully actuated position.

10. The robotic welding system as defined in claim 4, wherein the instructions, when executed, cause the processor to:
in response to a single actuation of the second input device, instruct the processor to generate a command in the robotic welding procedure; and
in response to a double actuation of the second input device, activate the masking input.

11. The robotic welding system as defined in claim 1, wherein the masking input comprises a rotation masking input, and the instructions, when executed, cause the processor to limit rotation of the robotic manipulator while the rotation masking input is active.

12. The robotic welding system as defined in claim 1, wherein the masking input comprises a translation masking input, and the instructions, when executed, cause the processor to limit translation of the robotic manipulator with respect to a predetermined point on the robotic manipulator while the translation masking input is active.

13. The robotic welding system as defined in claim 1, further comprising indicators for each translational dimension and each rotational dimension that can be controlled via the second device, wherein the instructions, when executed, cause the processor to control the indicators based on the inputs that are masked.
